(19) United States
(12) Patent Application Publication
(10) Pub. No.: US 2021/0138630 A1
(43) Pub. Date: May 13, 2021

(54) ROBOT

(71) Applicant: LG ELECTRONICS INC., Seoul (KR)

(72) Inventors: Jungkyu SON, Seoul (KR); Jinsu KIM, Seoul (KR); Boyeon KIM, Seoul (KR); Hyesun LEE, Seoul (KR); Bina KIM, Seoul (KR); Mina SUH, Seoul (KR); Jinwon KANG, Seoul (KR)

(73) Assignee: LG ELECTRONICS INC., Seoul (KR)

(21) Appl. No.: 16/784,590

(22) Filed: Feb. 7, 2020

(30) Foreign Application Priority Data
Nov. 12, 2019 (KR) 10-2019-0144101

(51) Int. Cl. B25J 5/00; B25J 9/00; A61G 5/04; A61G 5/10; B25J 11/00

(52) U.S. Cl. CPC B25J 5/007; B25J 9/0009; B25J 11/009; A61G 5/10; A61G 5/04

(57) ABSTRACT

Provided is a robot including a main body provided with a traveling wheel and at least one accessory separably mounted on the main body. The accessory includes a supporter on which an article is supported and a supporter locker disposed on the supporter, the supporter locker being provided with a locking portion hooked with the main body.

### CROSS-REFERENCE TO RELATED APPLICATIONS

This application claims the benefit of priority to Korean Patent Application No. 10-2019-0144101, filed on Nov. 12, 2019 in the Korean Intellectual Property Office, the disclosure of which is incorporated herein by reference in its entirety.

### FIELD OF THE DISCLOSURE

The present invention relates to a robot.

Robots are machines that automatically process given tasks or operate with their own capabilities. The application fields of robots are generally classified into industrial robots, medical robots, aerospace robots, and underwater robots. Recently, communication robots that can communicate with humans by voices or gestures have been increasing.

In recent years, there has been a trend of increasing in number of guidance robots, which provide a variety of guidance services at the airport, government offices, etc., a transport robot for transporting goods, or a boarding robot on which the user boards.

An example of a robot capable of carrying an article may be an intelligent caddy robot disclosed in Korea Patent Publication No. 10-2013-0119582 (Published on Nov. 1, 2013). The intelligent caddy robot includes a vehicle body constituted by a supporter disposed on an upper portion thereof to stably support golf equipment and a wheel disposed on a lower portion thereof to drive the robot. The supporter disposed on the upper portion of the vehicle body may be foldable to the vehicle body so as to be easily carried.

### SUMMARY

The robot according to the related art has high possibility of a loss of the article mounted on the supporter.

Embodiments provide a robot in which an accessory, on which an article is supported, is capable of being easily replaced.

Embodiments also provide a robot that is capable of minimizing a loss of an article, which is supported on an accessory, or the accessory.

In an embodiment, a robot includes: a main body provided with a traveling wheel; and at least one accessory separably (i.e., removably) mounted on the main body, wherein the accessory includes: a supporter on which an article is supported; and a supporter locker disposed on the supporter, the supporter locker being provided with a locking portion hooked with the main body.

An insertion portion into which the supporter locker is inserted and a hook groove with which the locking portion is hooked may be provided in the main body.

The supporter locker may include: a locking housing inserted into the insertion portion; and a locking body disposed in the locking housing, the locking body being provided with the locking portion.

A through-hole through which the locking portion passes may be defined in the locking housing.

The locking portion may be provided in plurality, which are spaced apart from each other. Each of the plurality of locking portions may be elastically bent.

The locking body may include a handle extending to the outside of the locking housing.

The supporter locker may further include an elastic member configured to elastically support the locking body.

A contact body that is spaced apart from the supporter locker and contacts an outer surface of the main body may be disposed on the supporter.

An article accommodation groove into which the article is accommodated may be defined in the supporter. The accessory may further include a stopper movably disposed on the supporter to prevent the article accommodated in the article accommodation groove from being separated.

The article accommodation groove may have top, bottom, and side surfaces, which are opened.

The stopper may move to a stop position at which the opened side surface is blocked and a release position at which the opened side surface is not blocked.

The accessory may further include a spring that allows the stopper to move to a release position, at which the article accommodation groove is not blocked.

The robot may further include a pusher configured to allow the stopper to move to a stop position at which the separation of the article is prevented.

The pusher may include: a pushing body movably disposed on the main body to push the stopper to the stop position; a motor disposed on the main body; and a power transmission member configured to transmit driving force of the motor to the pushing body.

In another embodiment, a robot includes: a main body provided with a traveling wheel; and

at least one accessory separably mounted on the main body, wherein the accessory includes:

a supporter in which an article accommodation groove is defined and on which an article is supported; and a stopper movably disposed on the supporter to prevent an article accommodated in the article accommodation groove from being separated, wherein a pusher configured to allow the stopper to move to a stop position at which the separation of the article is prevented is disposed on the main body.

The article accommodation groove may have top, bottom, and side surfaces, which are opened, and the stopper may move to a stop position at which the opened side surface is blocked and a release position at which the opened side surface is not blocked.

The stopper may further include a spring that moves to a release position, at which the article accommodation groove is not blocked, to elastically support the stopper.

The pusher may include: a pushing body movably disposed on the main body to push the stopper to the stop position; a motor; and a power transmission member configured to transmit driving force of the motor to the pushing body.

In further another embodiment, a robot includes: a main body provided with a traveling wheel; a seating body disposed on an upper portion of the main body; an accessory separably mounted on the main body or the seating body, wherein the accessory includes: a supporter on an article is supported; a supporter locker comprising a locking portion hooked with the main body or the seating body; and a stopper movably disposed on the supporter to prevent the article accommodated in the supporter from being separated.

An insertion portion into which the supporter locker is inserted and a hook groove with which the locking portion is hooked may be provided in the main body or the seating body, and the supporter locker may include: a locking housing inserted into the insertion portion; and a locking body disposed in the locking housing, the locking body being provided with the locking portion.

A pusher configured to allow the stopper to move to a stop position at which the separation of the article is prevented may be disposed on the main body or the seating body.

The pusher may include: a pushing body movably disposed on the main body or the seating body to push the stopper to the stop position; a motor; and a power transmission member configured to transmit driving force of the motor to the pushing body.

The details of one or more implementations are set forth in the accompanying drawings and the description below. Other features will be apparent from the description and drawings, and from the claims.

### BRIEF DESCRIPTION OF THE DRAWINGS

FIG. 1 is a view illustrating an AI device constituting a robot system according to an embodiment.

FIG. 2 is a view illustrating an AI server of a robot system according to an embodiment.

FIG. 3 is a view illustrating an AI system to which a robot system according to an embodiment is applied.

FIG. 4 is a perspective view of a robot according to an embodiment.

FIG. 5 is a plan view of the robot according to an embodiment.

FIG. 6 is a front view of the robot according to an embodiment.

FIG. 7 is a side view of the robot according to an embodiment.

FIG. 8 is a perspective view of the robot illustrating a state in which an accessory is separated from a main body according to an embodiment.

FIG. 9 is a perspective view of the robot illustrating a state in which the accessory is mounted on the main body according to an embodiment.

FIG. 10 is a perspective view of the robot illustrating a state in which an article is supported on the accessory according to an embodiment.

FIG. 11 is a perspective view of the robot illustrating a case in which a stopper of the accessory prevents the article from being arbitrarily (i.e., unintentionally) separated according to an embodiment.

FIG. 12 is a cross-sectional view of an accessory mounting portion of the robot according to an embodiment.

FIG. 13 is an exploded perspective view of the accessory according to an embodiment.

FIG. 14 is a cross-sectional view illustrating a state in which the accessory is locked with the main body according to an embodiment.

FIG. 15 is a cross-sectional view illustrating a state in which the locking of the accessory is released to be separated from the main body according to an embodiment.

FIG. 16 is a perspective view of a pusher and the accessory when the stopper of the accessory is disposed at a stop position.

FIG. 17 is a perspective view of the pusher and the accessory when the stopper of the accessory is disposed at a release position.

### DETAILED DESCRIPTION OF THE EMBODIMENTS

Hereinafter, detailed embodiments will be described in detail with reference to the accompanying drawings.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

FIG. 1 illustrates an AI device 100 including a robot according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communicator 110, an input interface 120, a learning processor 130, a sensor 140, an output interface 150, a memory 170, and a processor 180.

The communicator 110 may transmit and receive data to and from external devices such as other AI devices 100a to 100e and the AI server 500 by using wire/wireless communication technology. For example, the communicator 110 may transmit and receive sensor information, a user input, a learning model, and a control signal to and from external devices.

The communication technology used by the communicator 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

At this time, the input interface 120 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 120 may acquire a learning data for model learning and an input data to be used when an output is acquired by using learning model. The input interface 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 540 of the AI server 500.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensor 140 may acquire at least one of internal information about the AI device 100, ambient environment information about the AI device 100, and user information by using various sensors.

Examples of the sensors included in the sensor 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 150 may generate an output related to a visual sense, an auditory sense, or a haptic sense.

At this time, the output interface 150 may include a display unit for outputting time information, a speaker for outputting auditory information, and a haptic module for outputting haptic information.

The memory 170 may store data that supports various functions of the AI device 100. For example, the memory 170 may store input data acquired by the input interface 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 540 of the AI server 500, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 500. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 500 connected to a robot according to an embodiment of the present invention.

Referring to FIG. 2, the AI server 500 may refer to a device that learns an artificial neural network by using a machine learning algorithm or uses a learned artificial neural network. The AI server 500 may include a plurality of servers to perform distributed processing, or may be defined as a 5G network. At this time, the AI server 500 may be included as a partial configuration of the AI device 100, and may perform at least part of the AI processing together.

The AI server 500 may include a communicator 510, a memory 530, a learning processor 540, a processor 520, and the like.

The communicator 510 can transmit and receive data to and from an external device such as the AI device 100.

The memory 530 may include a model storage unit 531. The model storage unit 531 may store a learning or learned model (or an artificial neural network 531a) through the learning processor 540.

The learning processor 540 may learn the artificial neural network 531a by using the learning data. The learning model may be used in a state of being mounted on the AI server 500 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 530.

The processor 520 may infer the result value for new input data by using the learning model and may generate a response or a control command based on the inferred result value.

FIG. 3 illustrates an AI system 1 according to an embodiment of the present invention.

Referring to FIG. 3, in the AI system 1, at least one of an AI server 500, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 500 configuring the AI system 1 may be connected to each other through the cloud network 10. In particular, each of the devices 100a to 100e and 500 may communicate with each other through a base station, but may directly communicate with each other without using a base station.

The AI server 500 may include a server that performs AI processing and a server that performs operations on big data.

The AI server 500 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 500 may learn the artificial neural network according to the machine learning algorithm instead of the AI devices 100a to 100e, and may directly store the learning model or transmit the learning model to the AI devices 100a to 100e.

At this time, the AI server 500 may receive input data from the AI devices 100a to 100e, may infer the result value for the accommodated input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 500.

At this time, the robot 100a may perform the operation by generating the result by directly using the learning model, but the sensor information may be transmitted to the external device such as the AI server 500 and the generated result may be accommodated to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

Hereinafter, the robot 100a will be described as an example of the boarding robot on which the user is capable of boarding.

FIG. 4 is a perspective view of a robot according to an embodiment, FIG. 5 is a plan view of the robot according to an embodiment, FIG. 6 is a front view of the robot according to an embodiment, and FIG. 7 is a side view of the robot according to an embodiment.

The robot 100a may include a main body 200.

The main body 200 may include at least one traveling wheel and may be a traveling module or a mobile robot that is capable of traveling according to a user's input or may be capable of traveling autonomously.

The main body 200 may be an assembly of a plurality of parts, and the main body 200 may further include a driving mechanism (or traveling mechanism) that is connected to the traveling wheel to allow the traveling wheel to rotate forward and backward, such as a motor.

The traveling wheel may be provided in a pair on the main body 200. The pair of traveling wheels 202 and 204 may be provided on the main body 200 so as to be spaced apart from each other in a left-right direction Y (i.e., horizontal direction).

The driving mechanism may include a traveling motor generating driving force for allowing the traveling wheels 202 and 204 to rotate. In an example of the driving mechanism, the traveling motor may be directly connected to the traveling wheels 202 and 204 so that the traveling wheels 202 and 204 directly rotate forward and backward by the traveling motor. In another example of the driving mechanism, the traveling motor may be connected to the traveling wheels 202 and 204 through various power transmission members such as a rotation shaft and gears to allow the traveling wheels 202 and 204 to rotate forward and backward through at least one power transmission member.

The main body 200 may include a separate steering wheel (or steering mechanism) disposed to be spaced apart from the traveling wheels 202 and 204 so as to switch a traveling direction of the robot 100a. The direction of the steering wheel and the traveling direction of the main body 200 may be determined by a steering 600 that will be described below.

The main body 200 may not include the separate steering wheel for switching the traveling direction of the main body 200, and the traveling direction of the main body 200 may be determined using a pair of traveling wheels 202 and 204. The traveling direction of the main body 200 may be determined using the rotation direction of each of the pair of traveling wheels 202 and 204 or a difference in rotation speed of the pair of traveling wheels 202 and 204.

The main body 200 may be configured to allow the pair of traveling wheels 202 and 204 to rotate independently with respect to each other and include a pair of traveling motors 206 and 208 for allowing the pair of traveling wheels 202 and 204, respectively to rotate. The pair of traveling motors 206 and 208 may include a right traveling motor 206 for allowing the right traveling wheel 202 of the pair of traveling wheels 202 and 204 to rotate and a left traveling motor 208 for allowing the left traveling wheel 204 of the pair of traveling wheels 202 and 204 to rotate.

The main body 200 may further include a battery 210 for supplying power to each component of the robot 100a. The battery 210 may be disposed in the main body 200 in consideration of a center of gravity of the entire robot 100a.

The main body 200 may include a housing 220 defining an outer appearance. The housing 220 may be provided as an assembly of a plurality of members. The housing 220 may include a top surface 221, a bottom surface 222, and a circumferential surface 223.

Each of the top surface 221 and the bottom surface 222 of the housing 220 may have a planar shape, and the circumferential surface 223 of the housing 220 may have a curved shape.

The circumferential surface 223 may include a left surface 224, a right surface 225, a rear surface 226, and a front surface 227.

The left surface 224 may be convex toward a left side, and the right surface 225 may be convex toward a right side. And, the rear surface 226 may be convex toward a rear side between an upper end and a lower end. The front surface 227 may be convex forward between the upper and lower ends.

The upper end of the front surface 227 of the circumferential surface 223 may extend closer to a rear end among a front end of the top surface 221 and the rear end of the top surface 221.

The circumferential surface 223 may further include a plane 228 extending from one side of the convex front surface 227 to the front end of the top surface 221. The plane 228 may be an inclined surface that is inclined to face in a front lower direction.

The housing 220 may further include an upper rear surface 229 extending upward from an upper portion of the convex rear surface 226.

The housing 220 includes a lower housing 220a including a top surface 221, a bottom surface 222, and a circumferential surface 223 and an upper housing 220b extending from one side of the lower housing 220a to protrude upward and including an upper rear surface 229.

The lower housing 220a may be provided in a spherical shape of which each of top and bottom surfaces 221 and 222 are flat as a whole.

The upper housing 220b may extend from a rear upper portion of the lower housing 220a to a rear side of a backrest 320 to be described later.

The traveling wheels 202 and 204 may be rotatably disposed in the housing 220, and a lower portion of each of the traveling wheels 202 and 204 may be disposed in the housing 220 to pass through a wheel through-hole defined in a lower portion of the housing 220.

A space may be defined in the housing 220, and the battery 210 may be accommodated in the space defined in the housing 220.

The robot 100a may further include a seating body 300 disposed above the main body 200 and a foot supporter 400 disposed in front of the main body 200.

The seating body 300 may be configured to allow the user to be seated (i.e., a user may sit on the seating body 300). The seating body 300 may be provided with a seat for allowing the user to be seated thereon. Also, the seating body 300 may be provided with an armrest for allowing a user's arm to be placed. A height of the armrest may be higher than a height of the seat.

The seating body 300 may further include a seat body 310 on which the user sits and a backrest 320 on which the user leans back.

The seat body 310 may include a lower cushion 311 and a lower seat body 312 on which the lower cushion 311 is mounted.

The lower cushion 311 may be disposed on a top surface of the lower seat body 312. The lower cushion 311 may be provided to be more elastic than the lower seat body 312.

The lower seat body 312 may be disposed on an upper portion of the housing 220, in particular, the lower housing 220a. The lower seat body 312 may cover a space defined in the housing 220.

The seat body 310 may not include the lower cushion 311, but may include the lower seat body 312.

The backrest 320 may include a rear cushion 321 and a rear seat body 322 supporting the rear cushion 321. The rear seat body 322 may be supported by a rear supporter 324, and the backrest 320 may further include the rear supporter 324.

The rear cushion 321 may be disposed on a front surface of the rear seat body 322. The rear cushion 321 may be provided to be more elastic than the rear seat body 322.

The rear seat body 322 may entirely or partially overlap the upper housing 220b in a front-rear direction (i.e., longitudinal direction), and the rear supporter 324 may overlap the upper housing 220b in the front-rear direction. The rear seat body 322 and the rear supporter 324 may be protected by the upper housing 220b.

A lower portion of the rear supporter 324 may be connected to the lower seat body 312. The rear supporter 324 may be configured so that an upper part thereof is bent with respect to the lower part thereof. The lower portion of the rear supporter 324 may be rotatably connected to the lower seat body 312 by a hinge shaft, and the backrest 320 may be disposed to rotate about the lower portion.

The backrest 320 may not include the rear cushion 321, but may include the rear seat body 322 and the rear supporter 324.

The armrest may be disposed in the seat body 310 so as to move forward and backward. The armrest may be provided in a pair on the seating body 300.

The pair of armrests 330 and 340 may include a right armrest 330 and a left armrest 340 and the right armrest 330 and the left armrest 340 may be spaced apart from each other in the left-right direction Y and may be arranged symmetrical to each other in the left-right direction Y.

The pair of armrests 330 and 340 may be disposed on the seat body 310, in particular, the lower seat body 312 so as to move forward and backward, and a lower portion of each of the pair of armrests 330 and 340 may be inserted into the lower seat body 312. The lower portion of each of the pair of armrests 330 and 340 may be guided to move forward and backward in a front-rear direction X along a guide provided on the seat body 310.

The foot supporter 400 may be disposed on the main body 200. The foot supporter 400 may be disposed on the main body 200 to protrude in the front-rear direction. The foot supporter 400 may be disposed at a front lower portion of the main body 200. The foot supporter 400 may be disposed on the main body 200 to move forward and backward in the front-rear direction X.

An auxiliary wheel supporting the foot supporter 400 may be disposed on the foot supporter 400. A pair of auxiliary wheels 402 and 404 may be provided on the foot supporter 400, and the pair of auxiliary wheels 402 and 404 may be disposed the foot supporter 400 so as to be spaced apart from each other in a horizontal direction (i.e., along the Y-axis).

The robot 100a may include a steering 600 operated by the user. The steering 600 may be an adjusting device such as a jog & shuttle or a joystick.

The steering 600 may include a handle 612 held by the user. The steering 600 may be an input interface that is held and manipulated by the user's hand to input a traveling direction or traveling speed of the robot 100a.

The steering 600 may be disposed on at least one armrest. The steering 600 may be provided on each of the pair of armrests 330 and 340 and may be disposed on one of the pair of armrests 330 and 340.

The steering 600 may include a steering body 610 that is held by the user's hand. The steering body 610 may be a body which is held by the user's hand so as to be manipulated in various directions such as front, rear, left, and right directions. A handle 612 that is held by the user's hand may be disposed on an upper portion of the steering body 610. The steering body 610 may include a steering shaft 614 extending from a lower portion of the handle 612.

The user may hold the handle 612 while sitting on the seat body 310 to push the steering body 610 forward, pull the steering body 610 backward, or push the steering body to a left or right side.

For example, in the steering body 610, the handle 612 is inclined to one side such as the front, rear, left, or right side with respect to the steering shaft 614. The robot 100a may include a sensor sensing an inclination angle and an inclination direction of the steering body 610. The robot 100a may sense a steering direction or speed by the inclination angle (or inclination angle), the inclination direction, etc., of the steering body 610, which are sensed by the sensor.

For another example, in the steering body 610, the steering shaft 614 and the handle 612 may be disposed to move to the front, rear, left, or right side. The robot 100a may include a sensor sensing a position of the steering body 610. The robot 100a may sense the steering direction or speed according to the position of the steering body 610, which is sensed by the sensor.

For another example, in the steering body 610, the steering shaft 614 and the handle 612 may be disposed to rotate in a clockwise or counterclockwise direction. The robot 100a may include a sensor sensing a rotation angle of the steering body 610. The robot 100a may sense the steering direction or speed according to the rotation angle of the steering body 610, which is sensed by the sensor.

The sensor may transmit a signal of the sensed steering direction or speed to a processor 180, and the processor 180 may control the traveling motors 206 and 208 which will be described later according to the signal transmitted from the sensor.

The robot 100a may further include a display 700. The display 700 may be disposed on at least one of the pair of armrests 330 and 340. The display 700 may be disposed to rotate about a horizontal rotation center. The display 700 may be an output interface capable of displaying various information such as traveling information.

The display 700 may be rotatably connected to the steering housing 360. The display 700 may be connected to the front end of the steering housing 360.

The display connection portion 364 to which the display 700 is rotatably connected may be provided in the steering housing 360.

The display connection portion 364 may be spaced apart from the steering body 610 in a horizontal direction (i.e., along the Y-axis) when the steering body 610 ascends.

The robot 100a may further include a display rotator 370 that allows the display 700 to rotate. The display rotator 370 may be a rotating mechanism for allowing the display 700 connected to the display 700 to rotate. The display rotator 370 may include a display motor connected to the display 700 to allow the display 700 to rotate. Hereinafter, for convenience, like the display rotator 370, the display motor will be described with reference numeral 370. The display motor 370 may be disposed to be accommodated in the display connection portion 364. A motor space in which the display motor 370 is accommodated may be defined in the display connection portion 364.

The display motor 370 may be provided with a rotation shaft that allows the display 700 to rotate, and the rotation shaft may be disposed horizontally. The rotation shaft may be lengthily disposed in the left-right direction Y. The display motor 370 may allow the display 700 to rotate so that the display 700 is erected about a rotation axis, or the display 700 is laid down.

In this specification, the display 700 is not limited to being vertically erected, but may be defined to include being erected at a predetermined angle.

The display 700 may include a front surface 701 facing a front side and a rear surface 702 facing a rear side with respect to the standing display 700. A screen that is capable of providing a variety of information to the user may be disposed on the rear surface 702 of the display 700. A touch screen may be disposed on the rear surface 702 of the display 700, and the user may input various commands through the touch screen.

The display 700 may rotate side by side with the top surface of the armrest on the armrest. In this case, the front surface 701 when the display 700 is erected may be a top surface of the display 700, and the rear surface 702 when the display 700 is erected may be a bottom surface of the display play 700.

When the display 700 is laid horizontally, the screen of the display 700 is hidden from the outside, and the screen of the display 700 may be protected.

The robot 100a may further include at least one accessory that provides convenience to the user.

The accessory may be provided on the armrest or the main body 200, and a plurality of accessories may be provided on the robot 100a.

The robot 100a may include an accessory 800 (armrest accessory) provided on the armrest. The robot 100a may include an accessory 900 provided on the main body 200 (body accessory). The robot 100a may include both the accessory 800 provided on the armrest and the accessory 900 provided on the main body 200.

For example, the accessory 800 provided on the armrest may be a cup holder into which a cup is seated. For another example, the accessory 800 provided on the armrest may be a sub armrest having the same size and shape as the steering housing 360 but without an opening 362 defined in an upper portion thereof.

The steering housing 360 according to this embodiment may be selectively disposed on the armrest body 350 of the left armrest 340 or the armrest body 350 of the right armrest 330 for the convenience of the user. That is, the accessory such as the cup holder or a sub armrest may be disposed on the armrest body 350 of the armrest, in which the steering housing 360 is not disposed, among the left armrest 340 and the right armrest 330 and may support the user's arm together with the armrest body 350.

The accessory 800 provided on the armrest is not limited to the cup holder or the sub armrest, and also is not limited to the kind thereof as long as it provides the user's convenience and is accommodated in the accommodation portion 352.

An opening 362 may be defined in the armrest, and an inner space S in which a portion of the steering 600 is accommodated may be defined in the armrest. When the robot 100a includes a pair of armrests 330 and 340, the steering 600 may be disposed on one of the pair of armrests 330 and 340.

At least one of the pair of armrests 330 and 340 may be an assembly of a plurality of members, and at least one of the pair of armrests 330 and 340 may include the armrest body 350 and the steering housing 360.

One of the pair of armrests 330 and 340 may include the armrest body 350 and the steering housing 360 disposed on the armrest body 350. An accommodation portion 352 in which the steering housing 360 is accommodated may be defined in the armrest body 350.

The accommodation portion 352 may be provided in a shape that is recessed in the armrest body 350. A top surface of the accommodation portion 352 may be opened. Each of the top and front surfaces of the accommodation portion 352 may be opened.

The steering housing 360 may be inserted into and accommodated in the accommodation portion 352 and may be protected by the accommodation portion 352.

The steering housing 360 may surround at least a portion of the steering 600 and may protect the steering 600.

The other one of the pair of armrests 330 and 340 may include the armrest body 350 and may further include an accessory 800 disposed on the armrest body 350. The armrest body 350 may be provided with the accommodating portion 352 in which the accessory 800 is accommodated.

The pair of armrests 330 and 340 may include the armrest body 350 having the same structure, and the steering housing 360 and the accessory 800 may be disposed symmetrical to each other in the horizontal direction. Each of the pair of armrests 330 and 340 may be provided with the accommodation portions 352 having the same shape and the same size.

The accessory 800 and the steering housing 360 may have the same size and outline shape.

The steering housing 360 and the accessory 800 may have the same shape and size and may be disposed symmetrical to each other with respect to the seating body 300.

The steering housing 360 may constitute a steering assembly together with steering 600. The steering assembly may be selectively disposed together with the accessory 800.

When the steering housing 360 is disposed on the armrest body 350 of the right armrest 330, the accessory 800 may be disposed on the armrest body 350 of the left armrest 340, and vice versa. When the steering housing 360 is disposed on the armrest body 350 of the left armrest 340, the accessory 800 may be disposed on the armrest body 350 of the right armrest 330.

For example, the accessory 900 provided on the main body 200 may be a supporter on which a user's baggage (e.g., a carrier) is placed. For another example, the accessory 900 provided on the main body 200 may be a supporter on which a medical device (e.g., crutches, medicines, etc.) assisting user's walk is supported. The accessory 900 provided on the main body 200 is not limited to the supporter, and also, the accessory 900 is not limited in kind as long as the accessory 900 moves with the user. Various kinds of accessories 900 may be separably attached to the main body 200.

FIG. 8 is a perspective view illustrating a state in which the accessory is separated from the main body according to an embodiment, FIG. 9 is a perspective view illustrating a state in which the accessory is mounted on the main body according to an embodiment, FIG. 10 is a perspective view illustrating a state in which an article is supported on the accessory according to an embodiment, and FIG. 11 is a perspective view illustrate a case in which a stopper of the accessory prevents the article from being arbitrarily separated according to an embodiment.

The accessory 900 may include a supporter 920 on which the article 910 is supported and may be separably mounted to the main body 200 or the seating body 300.

For example, an article 910 supported on the supporter 920 may be a crutch that is used under the user's armpit, worn on the arm, or grasped by the hand, or a medical aid such as a walking aid to assist a person with a traffic weak. The article 910 mounted on the supporter 920 is not limited to the clothing device, and various things that the user who is seated on the seating body 300 wish to carry are applicable.

At least one article accommodation groove 922 in which the article 910 is accommodated may be defined in the supporter 920. The whole or a portion of the article 910 may be inserted into and accommodated in the article accommodation groove 922, and the article 910 in the article accommodation groove 922 may be supported by the supporter 920.

The accessory 900 may include a supporter locker 930. The supporter locker 930 may the accessory 900 to the main body 200 or the seating body 300 so as to be maintained on the main body 200 or the seating body 300 without being arbitrarily separated from the main body 200 or the seating body 300. The supporter locker 930 may be a supporter mounter separably mounted on the main body 200 or the seating body 300.

The supporter locker 930 may have a locking portion 952 that is hooked with the main body 200 or the seating body 300. When the locking portion 952 is hooked with the main body 200 or the seating body 300, the accessory 900 may be locked to the main body 200 or the seating body 300. If the locking portion 952 is not hooked with the main body 200 or the seating body 300, the accessory 900 may be unlocked to the main body 200 or the seating body 300. Here the user may pull the accessory 900 in a direction opposite to the mounting direction to separate the accessory 900.

The supporter 920 may be locked to the main body 200 or the seating body 300 by the supporter locker 930. The supporter locker 930 may assist the supporter 920 to be fixed to the main body 200 or the seating body 300 with high reliability.

The supporter locker 930 may be a kind of accessory locker and may minimize the separation and loss of the supporter 920 and the article 910 supported on the supporter 920.

When unlocking the supporter locker 930, the accessory 900 is not restricted to the main body 200 or the seating body 300 and may be easily separated from the main body 200 or the seating body 300.

The accessory 900 may include a stopper 970 that prevents the separation of the article 910 accommodated in the supporter 920.

The stopper 970 may be disposed to be movable on the supporter 920 and may move to a stop position P1 and a release position P2.

As illustrated in FIG. 11, the stop position P1 may be a position at which a portion of the stopper 970 blocks the article 910 accommodated in the article accommodation groove 922 and also be defined as a position at which the arbitrary movement and separation of the article 910 accommodated in the article accommodation groove 922.

As illustrated in FIG. 10, the release position P2 may be a position at which the stopper 970 does not block the article 910 and also be defined as a position at which the article 910 accommodated in the article accommodation groove 922 is separated from the article accommodation groove 922 without interfering with the stopper 970.

The stopper 970 may be a kind of article locker. Here, the article 910 may not easily separate from the supporter 902 during the locking (i.e., while the stopper 970 is disposed at the stop position P1), and thus, possibility of a loss of the article 910 may be minimized.

FIG. 12 is a cross-sectional view of an accessory mounting portion of the robot according to an embodiment, FIG. 13 is an exploded perspective view of the accessory according to an embodiment, FIG. 14 is a cross-sectional view illustrating a state in which the accessory is locked with the main body according to an embodiment, FIG. 15 is a cross-sectional view illustrating a state in which the locking of the accessory is released to be separated from the main body according to an embodiment, FIG. 16 is a perspective view of a pusher and the accessory when the stopper of the accessory is disposed at a stop position, and FIG. 17 is a perspective view of the pusher and the accessory when the stopper of the accessory is disposed at a release position.

An insertion portion 230 into the whole or a portion of the supporter locker 930 is inserted may be defined in the main body 200 or the seating body 300. Also, a hook groove 232 with which the locking portion 952 is hooked may be defined in the main body 200 or the seating body 300.

An insertion portion 230 may be defined to be opened in the mounting direction (for example, front-rear direction X) of the accessory 900 in the rear portion of the main body 200 and may have a shape that passes through a portion of the main body 200. The insertion portion 230 may have a length that is enough so that a portion of a locking housing 940, which will be described below, is inserted.

The accessory 900 may move forward in a state of being disposed behind the main body 200 so that the supporter locker 930 is inserted into the insertion portion 230.

The hook groove 232 may be defined to face the insertion portion 230. The hook groove 232 may be defined at a position at which the locking portion 952 reaches when the supporter locker 930 is inserted into the insertion portion 230. The locking portion 952 of the accessory 900 may be inserted into the insertion portion 230 together with the locking housing 940. Also, the locking portion 952 of the accessory 900 may be inserted into the hook groove 232 as illustrated in FIG. 14 when the locking portion 952 of the accessory 900 enters the insertion portion 230 to reach the position in which the hook groove 232 is defined.

An inner body 231 may be disposed inside the main body 200, and the insertion portion 230 and the hook groove 232 may be defined in the inner body 231. The inner body 231 may be provided as one member or may be provided as a plurality of members.

The insertion portion 230 may be defined to pass through the inner body 231 in a horizontal direction, and the hook groove 232 may be defined to have a recessed shape in the surface defining the insertion portion 230 of the inner body 231.

The portion inserted into the insertion portion 230 of the locking housing 940 may be supported by being in contact with the inner body 231 defining the insertion portion 230 of the main body 200, and the locking portion 952 disposed in the locking housing 940 may extend from the insertion portion 230 to the hook groove 232 and then be hooked with the hook groove 232.

A plurality of hook grooves 232 may be provided, and at least one pair of hook grooves 232 may be provided. The hook groove 232 may include an upper hook groove and a lower hook groove. The upper hook groove may be defined in a surface of the inner body 231 facing a top surface of the supporter locker 930 and may be defined in a shape that is recessed upward. The lower hook groove may be defined in a surface of the inner body 231 facing a bottom surface of the supporter locker 930 and may be defined in a shape that is recessed downward.

The supporter locker 930 may be provided as an assembly of a plurality of members. The supporter locker 930 may include a locking housing 940 inserted into the insertion portion 230 and a locking body 950 disposed in the locking housing 940 and provided with a locking portion 952. The supporter locker 930 may further include an elastic member 960 that elastically supports the locking body 950.

The locking housing 940 may have a flat box shape having a low height and a long length. The locking housing 940 may be inserted into the insertion portion 230 at a rear side of the insertion portion 230. A front portion of the locking housing 940 including a front end of the locking housing 940 may have a size less than a size of the insertion portion 230 and may be inserted into the insertion portion 230 so as to be supported by the insertion portion 230.

The locking housing 940 may have a through-hole 942 through which the locking portion 952 passes. The through-hole 942 may be defined in a portion of the locking housing 940, which is inserted into the insertion portion 230, i.e., the front portion of the locking housing 940. When the front portion of the locking housing 940 is inserted into the insertion portion 230, the through-hole 942 may be defined inside the insertion portion 230 and may not be visible from the outside. The through-hole 942 may face the hook groove 232 inside the insertion portion 230, and the locking portion 952 may be inserted into the hook groove 232 in a state in which the locking portion 952 passes through the through-hole 942.

The supporter locker 930 may include a plurality of locking portions 952, the through-hole 942 may one-to-one correspond to the locking portion 952, and the plurality of through-holes 942 may be provided in the locking housing 940. The plurality of through-holes 942 may include an upper through-hole corresponding to the upper hook groove and a lower through-hole corresponding to the lower hook groove. The upper through-hole may be defined to pass through an upper plate of the locking housing 940 in the vertical direction. The lower through-hole may be defined to pass through a lower plate of the locking housing 940 in the vertical direction.

The locking housing 940 may have a space 944 in which the locking body 950 is movable. The space 944 may be defined between the upper plate of the locking housing 940 and the lower plate of the locking housing 940.

A gradient surface 946 that induces the plurality of locking portions 952 to be closer to each other when the locking body 950 is pulled backward may be disposed on an inner surface (i.e., a bottom surface of the upper plate and a top surface of the lower plate) of the locking housing 940. A pair of gradient surfaces 946 may be provided inside the locking housing 940. The gradient surfaces 946 may be provided on an inner top surface (i.e., the bottom surface of the upper plate) of the locking housing 940 and an inner bottom surface (i.e., the top surface of the lower plate) of the locking housing 940, respectively. The pair of gradient surfaces 946 may be provided to have a shape closer to each other as the elastic member 960 approaches.

The locking body 950 may include a plate body 954 that is capable of moving within the space 944 of the locking housing 940.

The locking portion 952 may be provided in plurality in the plate body 954, and the plurality of locking portions 952 may be provided in the plate body 954 so as to be spaced apart from each other. Each of the plurality of locking portions 952 may be disposed at one end of the plate body 954. One end of each of the plurality of locking portions 952 may be connected to the plate body 954, and the other end of each of the plurality of locking portions 952 may be a free end.

Each of the plurality of locking portions 952 may be elastically curved about one end. If no external force is applied to the plurality of locking portions 952, the plurality of locking portions 952 may be provided to maintain the shapes that are separated from each other.

When external force is applied to the plurality of locking portions 952, the plurality of locking portions 952 may be bent in a direction closer to each other (i.e., towards each other). When the external forces applied to the plurality of locking portions 952 are removed, the plurality of locking portions 952 may be spaced again from each other.

The locking portion 952 may be provided in a pair in the locking body 950, and the pair of locking portions 952 may be spaced apart in the vertical direction Z or the left-right direction Y. In this case, a pair of through-holes 942 spaced apart in the vertical direction Z or the left-right directions Y may be defined in the locking housing 940.

A gap G may be defined between the pair of locking portions 952 to allow the locking portions 952 to be elastically bent.

The locking body 950 may include a handle 958 extending to the outside of the locking housing 940. The handle 958 may be disposed to protrude to an opposite side of the locking portion 952 of the plate body 954. The handle 958 may protrude perpendicular to the plate body 954. The handle 958 may be disposed to protrude downward from the plate body 954 so that the handle 958 is not easily seen from the outside.

The front portion of the locking body 950 may be accommodated in the space 944 of the locking housing 940, the rear portion of the locking body 950 may be accommodated inside the supporter 920, and the handle 958 may protrude to extend to the outside of the supporter 920.

An elastic member accommodation hole 959 in which a portion of the elastic member 960 is accommodated may be defined in the locking body 950. The elastic member accommodation hole 959 may be defined in the plate body 954 and may be defined to be opened in a direction perpendicular to the moving direction of the plate body 954. When the plate body 954 moves in the front-rear direction, the elastic member accommodation hole 959 may be defined to pass through the plate body 954 in the vertical direction.

The elastic member 960 may be supported by the locking housing 940 to contact the locking body 950, particularly, the plate body 954, thereby elastically supporting the locking body 950 forward.

When the user grasps the handle 958 and pulls the handle backward, the locking body 950, in particular, the plate 954 may press the elastic member 960 (i.e., depress the elastic member 960 so as to move the plate body 954 backward), and when the external force applied to the locking body 950 is removed, the elastic member 960 may push the locking body 950, in particular, the plate body 954 forward.

On the other hand, a space 923 into which the supporter locker 930, in particular, a portion of the locking body 950 is accommodated may be defined in the supporter 920. A through-hole 925 through which the locking body 950 is movable may be defined in the supporter 920.

The supporter 920 may be provided as an assembly of a plurality of members. The supporter 920 may include a main supporter 924, in which a through-hole 925 is defined, and a sub supporter 926 coupled to the main supporter 924. The main supporter 924 may be larger than the sub supporter 926.

A space 923 in which a portion of the locking body 950 is accommodated may be defined between the main supporter 924 and the sub supporter 926.

The sub supporter 926 may be coupled to a rear portion of the main supporter 924, and the article accommodation groove 922 may be defined by the sub supporter 926 and the main supporter 924 between the sub supporter 926 and the main supporter 924.

At least one of the main supporter 924 or the sub supporter 926 may be provided with a handle through-portion 927 through which the handle 958 extends outward from the space 923 of the supporter 920. The handle 958 may extend below the handle through-portion 927 through the handle through-portion 927. The handle through-portion 927 may be defined to pass through one of the main supporter 924 and the sub supporter 926 in the vertical direction or may be defined to pass between the main supporter 924 and the sub supporter 926 in the vertical direction. An upper end of the handle 958 may be disposed between the main supporter 924 and the sub supporter 926, and a lower end of the handle 958 may be disposed below the handle through-portion 927.

After an operator or manager allows the hand UH to move under the handle through-portion 927, the operator 958 may pull the handle 958 in a direction (backward direction) opposite to the accessory mounting direction (forward direction), and the locking body 950 may move in the direction opposite to the accessory mounting direction. When the locking body 950 moves in the direction opposite to the accessory mounting direction, the pair of locking parts 952 may be bent out of the hook groove 232 while bending (i.e., elastically bend or elastically deform) in a direction closer to each other.

On the other hand, the supporter 920 may be provided with a contact body 928 contacting the outer surface of the main body 200 or the seating body 300. The contact body 928 may be provided on the supporter 920 to be spaced apart from the supporter locker 930. The contact body 928 may be disposed to protrude from the surface facing the main body 200 of the supporter 920. In the accessory 900, the supporter locker 930 and the contact body 928 may contact and be supported on the main body 200. Thus, the accessory 900 may be stably supported while minimizing shaking.

The robot 100a may further include a pusher 990 for allowing the stopper 970 to move. The pusher 990 may allow the stopper 970 to move so that the stopper moves to the stop position P1 at which the article 910 is prevented from being separated.

Hereinafter, the article accommodation groove 922, the stopper 970 and the pusher 990 will be described.

The top surface, the bottom surface, and the side surface of the article accommodation groove 922 may be opened, and the stopper 970 may be disposed to move to the stop position P1 at which the opened side surface of the article accommodation groove 922 is blocked and the release position P2 at which the opened side surface of the article accommodation groove 922 is not blocked.

The stopper 970 may include a stop body 972, a pin 974, and a connector 976.

The stop body 972 is a body that moves to the stop position P1 or the release position P2, and a size of the stop body 972 may be less than a size of the article accommodation groove 922.

When the stop body 972 moves to the stop position P1, the article accommodation groove 922 and the stop body 972 may surround an outer circumference of a portion of the article 910. The article accommodation groove 922 between the article accommodation groove 922 and the stop body 972 may be limited in horizontal movement by the portion defining the article accommodation groove 922 of the supporter 920 and the stop body 972.

The pin 974 may be lengthily disposed in the moving direction of the stop body 972. The movement direction of the stop body 972 may coincide with the mounting/separating direction of the accessory 900.

The mounting/separating direction of the accessory 900 may be a front-rear direction, the moving direction of the stop body 972 may be a front-rear direction, and the pin 974 may be elongated in the front-rear direction to move in the front-rear direction.

In more detail, the mounting direction of the accessory 900 may be a forward direction, and the detaching direction of the accessory 900 may be a backward direction. Also, the direction in which the stopper 970 moves from the release position P2 to the stop position P1 may be the backward direction, and the direction in which the stopper 970 moves from the stop position P1 to the release position P2 may be the forward direction.

The connector 976 may connect the stop body 972 to the pin 974. The stop body 972 and the pin 974 may protrude in opposite directions from the connector 976. The pin 984 may be provided to protrude in the forward direction of the connector 976, and the stop body 972 may be provided to protrude in the rear direction from the connector 976.

The accessory 900 may further include a spring 980 which supports the stopper 970 so that the stopper 970 does not block the article accommodation groove 922, i.e., moves to the release position P2. That is, the spring 980 may bias the stopper 970 toward the release position P2. The spring 980 may allow the stopper 970 to move so that the stopper 970 moves to the release position P2.

The spring 980 may be accommodated inside the locking housing 940 and may be disposed to surround an outer circumference of the pin 974. One side of the spring 980 may be connected to the stopper 970, and the other side of the spring 980 may be connected to the locking housing 940.

When no external force is applied to the stopper 970, the stopper 970 is pulled by the spring 980 to the release position P2, and when the external force is applied to the stopper 970 by the pusher 990, the stopper 970 may move to the stop position P1 while tensioning the spring 980.

The pusher 990 may allow the stopper 970 to move in a direction opposite to the mounting direction (forward direction) of the accessory 900 in the state in which the pusher 990 is disposed in the main body 200 or the seating body 300.

The pusher 990 may include a pushing body that pushes the stopper 970 to the stop position P1, a motor 998 disposed in the main body 200, and a power transmission member 999 that transmits driving force of the motor 998 to the pushing body 992.

The pushing body 992 may be disposed to be movable on the main body 200 or the seating body 300. The pushing body 992 may be movably accommodated inside the insertion portion 230.

The pushing body 992 may include a pin portion 993 contacting the pin 974 of the stopper 970 to push the pin 974 of the stopper 970 and a plate 994 which is connected to the pin portion 993 and to which the power transmission member 999 is connected.

The pin portion 993 may enter the locking housing 940 through a pin portion through-hole 948 defined in the locking housing 940 when the accessory 900 is mounted. The pin portion 993 may support the locking housing 940 while the locking housing 940 is inserted into the insertion portion 230, and the locking housing 940 may be guided to the pin portion 993 so as to be more stably inserted and supported.

A portion of the pin portion 993 inserted into the locking housing 940 may move into the locking housing 940 in the accessory mounting direction or in a direction opposite to the accessory mounting direction.

When the motor 998 operates to allow the pin portion 993 to move in the direction opposite to the accessory mounting direction, the pin portion 993 may press the pin 974 of the stopper 970 in the direction opposite to the accessory mounting direction.

The motor 998 may be mounted within the main body 200 and may be connected to the power transmission member 999.

The power transmission member 999 may transmit the driving force of the motor 998 to the pushing body 992. The power transmission member 999 may be connected to the plate 994 of the pushing body 992 and may allow the pushing body 992 to linearly move in the front-rear direction. The power transmission member 999 is applicable to a variety of structures such as a lever and a gear.

The robot 100a is not limited to include the motor 998 and the power transmission member 999 as long as the pushing body 992 moves in the direction opposite to the accessory mounting direction. For example, various linear driving mechanisms (e.g., a linear motor, a linear actuator, and the like) are applicable.

The robot 100a may include an authentication module such as a scanner capable of authenticating a person who uses the robot 100a (hereinafter, referred to as a user). The robot 100a may authenticate the user through various input interfaces 120 such as a touch screen provided on the display 700, a microphone capable of recognizing a user's voice command, and a control panel (not shown).

When the user is authenticated through the authentication module such as the scanner or the input interface 120, the pusher 990 may operate in a lock mode to allow the pushing body 992 to move in the direction opposite to the accessory mounting direction, and the pushing body 992 may press the stopper 970 to allow the stopper 970 to move to the stop position P1.

In the state in which the stopper 970 is disposed at the stop position P1, the user may input unlocking through the authentication module such as the scanner or the input interface 120 such as the display 700 or the control panel.

The pusher 990 may operate in the unlock mode to allow the pushing body 992 to move in the accessory mounting direction, and the spring 980 may push the stopper 970 to the release position P2. In this case, the user may easily remove the article 910 from the supporter 920 because the stopper 970 does not block the article accommodation groove 922.

According to an embodiment, the supporter locker may be locked to the main body or the seating body so that the loss of the supporter is minimized, and the loss of the goods supported on the supporter may be minimized.

In addition, the stopper may prevent the article supported on the supporter from being easily separated, thereby minimizing the loss of the article.

The above-disclosed subject matter is to be considered illustrative, and not restrictive, and the appended claims are intended to cover all such modifications, enhancements, and other implementations, which fall within the scope of the present disclosure.

Thus, the implementation of the present disclosure is to be considered illustrative, and not restrictive.

Therefore, the scope of the present disclosure is defined not by the detailed description of the invention but by the appended claims, and all differences within the scope will be construed as being included in the present disclosure.

What is claimed is:

1. A robot, comprising:
a main body including a traveling wheel; and
an accessory removably mounted on the main body,
wherein the accessory comprises:
a supporter configured to support an article; and
a supporter locker disposed on the supporter, the supporter locker being provided with a locking portion connected to the main body.

2. The robot according to claim 1, wherein the main body further includes:
an insertion portion, the supporter locker being disposed in the insertion portion; and a hook groove, the locking portion engaging the hook groove of the main body, and
wherein the supporter locker further includes:
a locking housing disposed in the insertion portion; and
a locking body disposed in the locking housing, the locking body being provided with the locking portion.

3. The robot according to claim 2, wherein the locking housing includes a through-hole, and
wherein the locking portion passes through the through-hole of the locking housing to engage the hook groove of the main body.

4. The robot according to claim 3, wherein the locking portion is provided in plurality,
wherein the locking portions are spaced apart from each other, and
wherein in response to an external force applied to the plurality of locking portions, each of the locking portions is configured to elastically deform.

5. The robot according to claim 4, wherein the locking body comprises a handle extending to outside of the locking housing.

6. The robot according to claim 4, wherein the supporter locker further comprises an elastic member configured to elastically support the locking body, and
wherein the elastic member of the supporter locker is provided inside of the locking housing.

7. The robot according to claim 1, wherein the supporter includes a contact body,
wherein the contact body is spaced apart from the supporter locker, and
wherein the contact body contacts an outer surface of the main body.

8. The robot according to claim 1, wherein the supporter includes an article accommodation groove into which the article is supported,
wherein the accessory further includes a stopper movably disposed on the supporter to prevent the article supported in the article accommodation groove from being separated, and
wherein the stopper is movable from a release position to a stop position.

9. The robot according to claim 8, wherein the article accommodation groove has a top surface, a bottom surface, and a side surface, the top surface, the bottom surface and the side surface being opened,
wherein in the stop position of the stopper, the stopper blocks the side surface of the accommodation groove to lock the article to the accessory, and
wherein in the release position of the stopper, the stopper does not block the side surface of the accommodation groove so that the article can be attached to the accessory or the article can be removed from the accessory.

10. The robot according to claim 8, wherein the accessory further comprises a spring supporting the stopper, the spring biasing the stopper towards the release position of the stopper.

11. The robot according to claim 8, further comprising a pusher configured to limit the movement of the stopper to allow the stopper to move to the stop position of the stopper.

12. The robot according to claim 11, wherein the pusher comprises:
a pushing body movably disposed on the main body, the pushing body being configured to push the stopper to the stop position;
a motor; and
a power transmission member configured to transmit a driving force of the motor to the pushing body.

13. A robot, comprising:
a main body including:
a traveling wheel; and
a pusher; and
an accessory removably mounted on the main body,
wherein the accessory comprises:
a supporter including an article accommodation groove, the article accommodation groove of the supporter being configured to support an article; and
a stopper movably disposed on the supporter to prevent the article accommodated in the article accommodation groove from being separated,
wherein the stopper is movable from a release position to a stop position,
wherein the pusher is configured to limit movement of the stopper to allow the stopper to move to the stop position, and
wherein at the stop position of the stopper, the article is locked to the accessory.

14. The robot according to claim 13, wherein the article accommodation groove has a top surface, a bottom surface, and a side surface, the top surface, the bottom surface and the side surface being opened,
wherein in the stop position of the stopper, the stopper blocks the side surface of the accommodation groove to lock the article to the accessory, and
wherein in the release position of the stopper, the stopper does not block the side surface of the accommodation groove so that the article can be attached to the accessory or the article can be removed from the accessory.

15. The robot according to claim 13, wherein the accessory further includes a spring supporting the stopper, the spring biasing the stopper towards the release position of the stopper.

16. The robot according to claim 13, wherein the pusher comprises:
a pushing body movably disposed on the main body, the pushing body being configured to push the stopper to the stop position;
a motor; and
a power transmission member configured to transmit a driving force of the motor to the pushing body.

17. The robot according to claim 13, wherein the accessory further includes a supporter locker disposed on the supporter, and
wherein the supporter locker includes a locking portion engaging the main body.

18. The robot according to claim 17, wherein the main body further includes:
an insertion portion, the supporter locker being disposed in the insertion portion; and
a hook groove, the locking portion engaging the hook groove of the main body, and wherein the supporter locker further includes:
a locking housing disposed in the insertion portion; and
a locking body disposed in the locking housing, the locking body being provided with the locking portion.

19. The robot according to claim 18, wherein the locking housing includes a through-hole, and
wherein the locking portion passes through the through-hole of the locking housing to engage the hook groove of the main body.

20. The robot according to claim 19, wherein the locking portion is provided in plurality,
wherein the locking portions are spaced apart from each other, and
wherein in response to an external force applied to the locking portions, each of the locking portions is configured to elastically deform.
